(19) United States
(12) Patent Application Publication
(10) Pub. No.: US 2009/0296391 A1
(43) Pub. Date: Dec. 3, 2009

(54) SOLID STATE LAMP LIGHTING SYSTEM

(75) Inventor: B.J. Adams, Spokane, WA (US)

Correspondence Address: K&L Gates LLP, 618 W. Riverside, Suite 300, SPOKANE, WA, 99201-0628, US

(73) Assignee: New Tech, LLC, Kansas City, MO (US)

(21) Appl. No.: 12/127,184

(22) Filed: May 27, 2008

(51) Int. Cl. F21V 21/00; H05B 41/36; F21V 29/00

(52) U.S. Cl. 362/249.02; 315/294; 362/373

(57) ABSTRACT

A LED lamp assembly includes a substrate, a plurality of LEDs and a circuit. The circuit can provide soft start pulses for driving the plurality of LEDs. The soft start pulses allow for greater drive energies to be used for emitting high power light. The plurality of LEDs can be disposed on the substrate, which can include a thermally conductive material that can facilitate heat transfer from the plurality of LEDs. The substrate can include a bore that can facilitate heat transfer when exposed to air, liquid, ice, or combinations thereof.

### FIELD OF THE INVENTION

The present invention relates to light emitting diode (LED) lighting systems, and more specifically, to high power LED lamps.

### BACKGROUND OF THE INVENTION

Light emitting diodes (LEDs) have been available since the early 1960's in various forms, and are now widely used in various applications. The relatively high efficacy of LEDs (in lumens per Watt) is the primary reason for their popularity. Tremendous power savings are possible when LED signals are used to replace traditional incandescent signals of similar luminous output.

An LED is an electronic element, which can radiate light when applying electric power. The lighting principle of LED is translating electric power to light energy, that is, doping a minute amount of carriers into a conjunction of p side, or anode, and n side, or cathode, (p-n junction) and continuously combining the minute amount of carriers with a major amount of carriers to form a LED. As in other diodes, current can flow easily from the p side to the n side, but not in the reverse direction. Charge-carriers—electrons and holes—can flow into the p-n junction from electrodes with different voltages. When an electron meets a hole, it can fall into a lower energy level, and can release energy in the form of a photon.

Because of the various advantages of LEDs, they are widely used in the illumination of electronic devices or lamps. Further, in order to increase the illuminating range and intensity thereof, a plurality of LEDs are usually combined to form a LED lamp set. However, with the increase in the number of LEDs and the subsequent development of high-power LEDs, the heat generated by the operation of the LEDs is inevitably increasing. Therefore, it is an important issue for those skilled in this art to provide a heat-dissipating structure for LED lamps.

One aspect of LED technology that is not satisfactorily resolved is the application of LEDs in high temperature environments. LED lamps exhibit a substantial light output sensitivity to temperature, and in fact are permanently degraded by excessive temperature. Recent experiments with a wide variety of LEDs suggest an exponential relationship of life versus operating temperature. The well known Arhenius function is an approximate model for LED degradation: D varies according to te^{kT}, where D is the degradation, t is time, e the base of natural logarithms, k an activation constant, and T the absolute temperature in degrees Kelvin. Recent developments in LED technology have extended the maximum recommended operating temperature to 85° C. These devices exhibit typical (half brightness) lives on the order of 100,000 hours at 25° C. However, degradation at or above 85° C. is very rapid as the LEDs degrade exponentially with increases in temperature. While such high temperatures might seem unusual for an LED operating environment, they are actually quite common.

To overcome the heat buildup within an LED system, manufacturers will often incorporate heat dissipation structures and systems within the LED package itself. However, the conventional heat-dissipating structures and systems can be bulky, unnecessarily complicated and/or ineffective. The lack of effective means to control overheating also limits the amount of drive energies that can be used to drive LEDs and therefore limits LEDs' use in high power lighting applications.

### SUMMARY OF THE INVENTION

The present invention provides numerous improvements addressing a number of described drawbacks inherent in prior approaches and others. It will be appreciated, however, that the invention is also amendable to other like applications.

One aspect of the present invention provides a LED lamp assembly with one or more LEDs and LED drive circuits that can provide soft start pulses to drive the LEDs. This advance is significant in that it can provide a steady light source useful for a variety of applications while allowing the LEDs (or a group of the LEDs) to emit high power light intermittently, thereby reducing the heat generated by the LED lamp assembly. Additionally, with this arrangement, there can be more time for heat transfer from the LEDs, thus allowing for greater drive energies to be used, which can result in higher power of the light emitted by the LED lamp assembly. This is particularly useful for applications that can be benefited by a high power light source without compromising the service life of the LEDs.

In one embodiment, the LED lamp assembly comprises a plurality of LEDs and a circuit that provides soft start pulses for driving the LEDs. In another embodiment, the circuit comprises a pulse generator for generating pulses, and a field effect transistor for switching current flow in response to pluses generated by the pulse generator for driving the LEDs. In one specific embodiment, the field effect transistor is optically switched and has a relative slow response time to pulses generated by the pulse generator.

Another aspect according to the present invention provides improved heat dissipating method and system for the LED lamp assembly. In one embodiment, the LEDs are disposed on a substrate comprising an elongated structure (e.g., polygonal tubular structure). In another embodiment, the elongated structure comprises an outer surface, an inner surface, and a bore extending in the direction of the longitudinal axis of the elongated structure defining the inner surface. In yet another embodiment, the LEDs are disposed along the outer surface of the elongated structure and are thermally coupled with the elongated structure, which can dissipate heat from the LEDs. In one specific embodiment, the LEDs maintain electrical insulation from the elongated structure.

In one embodiment, the elongated structure further comprises a cover above the LEDs. In another embodiment, the cover forms a hermetic seal covering the plurality of LEDs. This allows the LED lamp assembly to be used or placed in or around liquid, ice or both, which can allow for even greater heat dissipation of the LEDs.

Other advantages of the present invention will become apparent as the same becomes better understood by reference to the following detailed description when considered in connection with the accompanying illustrative drawings.

### BRIEF DESCRIPTION OF THE DRAWINGS

FIG. 1 is an illustration of a LED assembly according to embodiments of the present invention.

FIG. 2 is a block diagram of a LED drive circuit according to embodiments of the present invention.

FIG. 3 is another block diagram of a LED drive circuit according to embodiments of the present invention.

FIG. 4 is an illustration of a waveform generated during operation of a circuit shown in FIG. 3.

FIG. 5 is a schematic diagram of a LED drive circuit according to embodiments of the present invention.

FIG. 6 is an illustration of a waveform generated during operation of a circuit shown in FIG. 5.

### DEFINITION OF TERMS

To aid in understanding the following detailed description of the present invention, the terms and phrases used herein shall have the following, non-limiting, definitions:

As used herein, “circuit” means at least either a single component or a multiplicity of components, either active and/or passive, that are coupled together to provide a desired function.

### DETAILED DESCRIPTION

### I. Systems and Assemblies

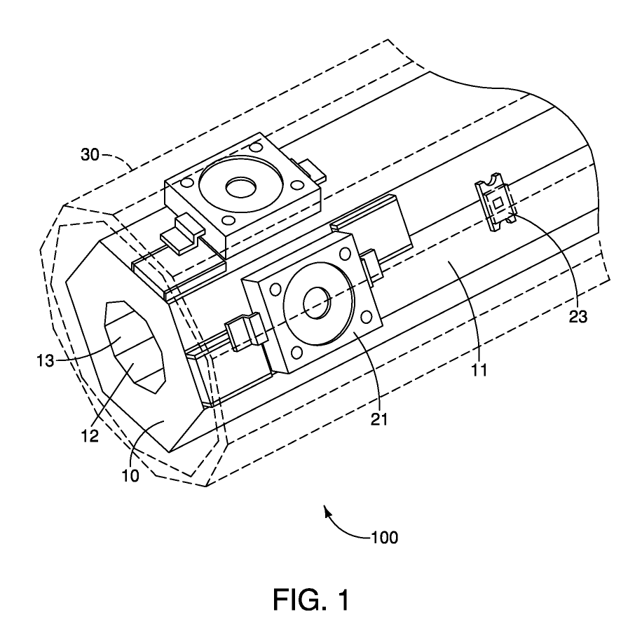

FIG. 1 depicts a LED lamp assembly 100 according to embodiments of the present invention. In this depicted embodiment, LED lamp assembly 100 comprises a substrate 10 that can have an outer surface 11 and a plurality of LEDs 21 and LEDs 23 that can be disposed along the outer surface 11 of the substrate 10, which can serve as a light-emitting surface. LEDs 21 and LEDs 23 can comprise high power LEDs (e.g., greater than or equal to about 0.1 W power). LEDs 21 and LEDs 23 can also comprise one or more types of LEDs. In one embodiment, one or more of LEDs 21 and LED 23 can comprise ultra lumen LEDs (e.g., OSRAM GmbH's LW W5SN model LEDs). In another embodiment, one or more of LEDs 21 and LEDs 23 can comprise 1206 type LEDs (e.g., NICHIA Corporation's NCSU033A model LEDs). The numbers, types and arrangement of the LEDs depicted in FIG. 1 are for illustration purposes only and are not intended to limit the scope of the present invention.

The wavelengths of light emitted from LEDs 23 and LEDs 21 can be infrared, visible, ultraviolet or combinations thereof, and can depend on the composition and condition of the semiconducting material used. LEDs 21 and LEDs 23 can comprise a variety of semiconductor materials, including: aluminum gallium arsenide (red and infrared), aluminum gallium phosphide (green), aluminum gallium indium phosphide (orange-red, orange, yellow, green), gallium arsenide phosphide (red, orange-red, orange, yellow), gallium phosphide (red, yellow, green), gallium nitride (green, blue, white), indium gallium nitride (450 nm-470 nm—near ultraviolet, blue, bluish-green), silicon carbide (blue), silicon (blue), sapphire (blue), zinc selenide (blue), diamond (ultraviolet), and aluminium nitride, aluminium gallium nitride, and aluminium gallium indium nitride (near to far ultraviolet).

The range of wavelengths of light emitted from LEDs 21 can be different from the range of wavelengths of light emitted from LEDs 23 and a feature of the present invention allows the generation of a third range of wavelengths of light that is a combination of the two provided by LEDs 21 and LEDs 23. The combination of the wavelengths can be controlled by the magnitude and duration of the voltage potential applied to the LEDs. As such, one or more of LEDs 21 and LEDs 23 can emit light simultaneously, alternatively or independently from each other.

LEDs 21 and LEDs 23 can be coupled in a manner that allows currents alternatively flow through LEDs 21 and LEDs 23, so that they can emit light when properly forwardly biased. In one specific embodiment, LEDs 21 and LEDs 23 can be driven by an opposite polarity current on a drive circuit so that, when voltage is applied, the current is allowed to flow through only one type of LEDs, so that light is emitted only from the LEDs through which the current flows. In another specific embodiment, LEDs 21 and LEDs 23 can be driven by more than one drive circuit (e.g., two) that allow them to emit light when properly forwardly biased.

Still referring to FIG. 1, cover 30 can be disposed on substrate 10 above LEDs 21 and LEDs 23. Cover 30 can comprise a material for maximum light diffusion (e.g., fluorine polymer or Dyneon™ THV fluorothermoplastic). Cover 30 can also comprise a material that can dampen vibrational shock for safer transport or operation of the LED lamp assembly. In one embodiment, cover 30 can form a hermetic seal (e.g., at either or both ends of substrate 10) covering LEDs 21 and LEDs 23, which can offer additional protections to the LEDs when the LED lamp assembly is used or placed in or around liquid, ice or other environments that may have a deleterious effect on the LEDs or the LED lamp assembly.

LED lamp assembly 100 can comprise a reflector (not shown) for redirecting light emissions. However, the lamp assembly can be used without a reflector, e.g., for omni-directional light emissions.

In this specific embodiment, an external dimension of LED lamp assembly 100 is 48 inches in length and 0.625 inches in diameter. However, the dimension is for illustration purposes only and is not intended to limit the scope of the present invention.

### II. Heat Sink

As shown in FIG. 1, LED lamp assembly 100 according to embodiments of the present invention can include substrate 10 on which a plurality of LEDs can be arranged. In one embodiment, LEDs 21 and LEDs 23 can be thermally coupled to substrate 10. In another embodiment, substrate 10 can comprise a thermally conductive material (e.g., a metal material such as copper or aluminum or a mixture of materials) that can facilitate heat transfer from the LEDs. In yet another embodiment, substrate 10 can comprise a thermally conductive but electrically nonconductive material (e.g., anodized, sealed aluminum) that can facilitate heat transfer but is electrically insulated.

In the embodiment shown in FIG. 1, substrate 10 can be cast in the shape of a hexagonal tube, but other shapes (e.g., cylindrical, polygonal, etc.) can also be used to serve the intended purposes of the present invention. In one embodiment, substrate 10 can comprise a bore 12 and an inner surface 13 that can facilitate heat transfer from the outer surface 11, e.g., when bore 12, inner surface 13, or both are exposed to air, liquid, ice or combinations thereof. This configuration has an additional advantage of providing structural integrity while allowing for automatic parts placement engineering. It also can provide consistent thermal management of the LEDs for more evenly generated light.

### III. Led Drive Circuit

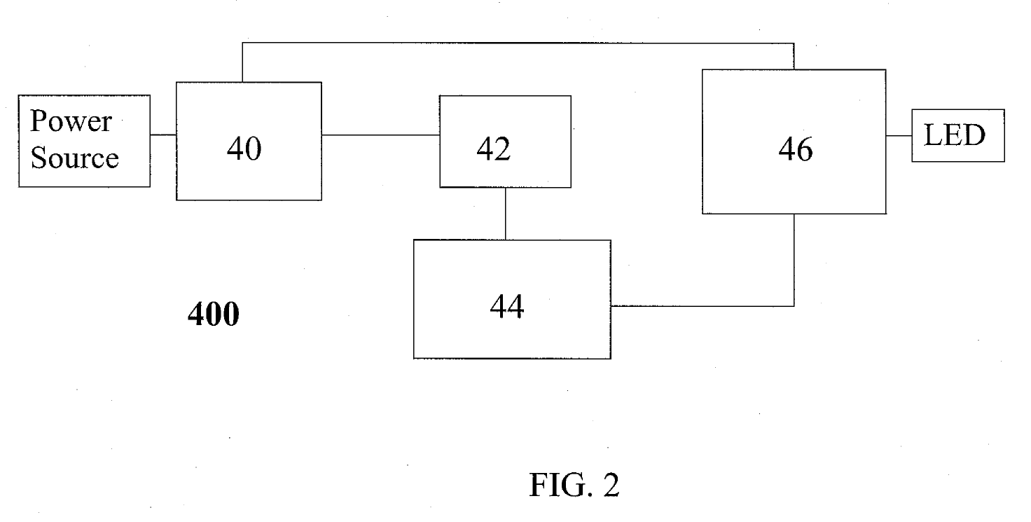

FIG. 2 illustrates a block diagram of a LED drive circuit 400 in accordance with embodiments of the present invention. LED drive circuit 400 can comprise a source power unit 40, a voltage regulator 42, a pulse generator 44, and an output regulator 46. Source power unit 40 can receive electric power from a power source (e.g., an alternating current (AC) source) and can provide or output conditioned electric power. In one embodiment, power unit 40 can comprise a transformer that can alternate an input voltage. In another embodiment, power unit 40 can comprise a rectifier that coverts AC to direct current (DC).

Voltage regulator 42 can maintain a substantially constant voltage level (e.g., 5 V_{AC}), which can be communicated with pulse generator 44. Pulse generator 44 can generate pulses having widths or durations ranging from minutes to under one picosecond. In one embodiment, pulse generator 44 can generate voltage pulses.

Pulse generator 44 can communicate with output regulator 46, which can output electric power (e.g., from source power unit 40) for driving one or more LEDs. Output regulator 46 can comprise a field effect transistor that can function as a switch in response to pulses generated by pulse generator 44, thereby regulating the electric power outputted by output regulator 46. In one embodiment, output regulator 46 can comprise a field effect transistor that is optically (e.g., LED) switched and has a relatively slow response time (e.g., in the range of 0.1 to 20 microseconds) to voltage changes. The results of this circuit combination can output a regulated, steady lower voltage, which can provide soft start pulses for driving LEDs without overshoot. This output can be communicated to LEDs through one or more resistors, which can further enhance the soft start of the drive pulses.

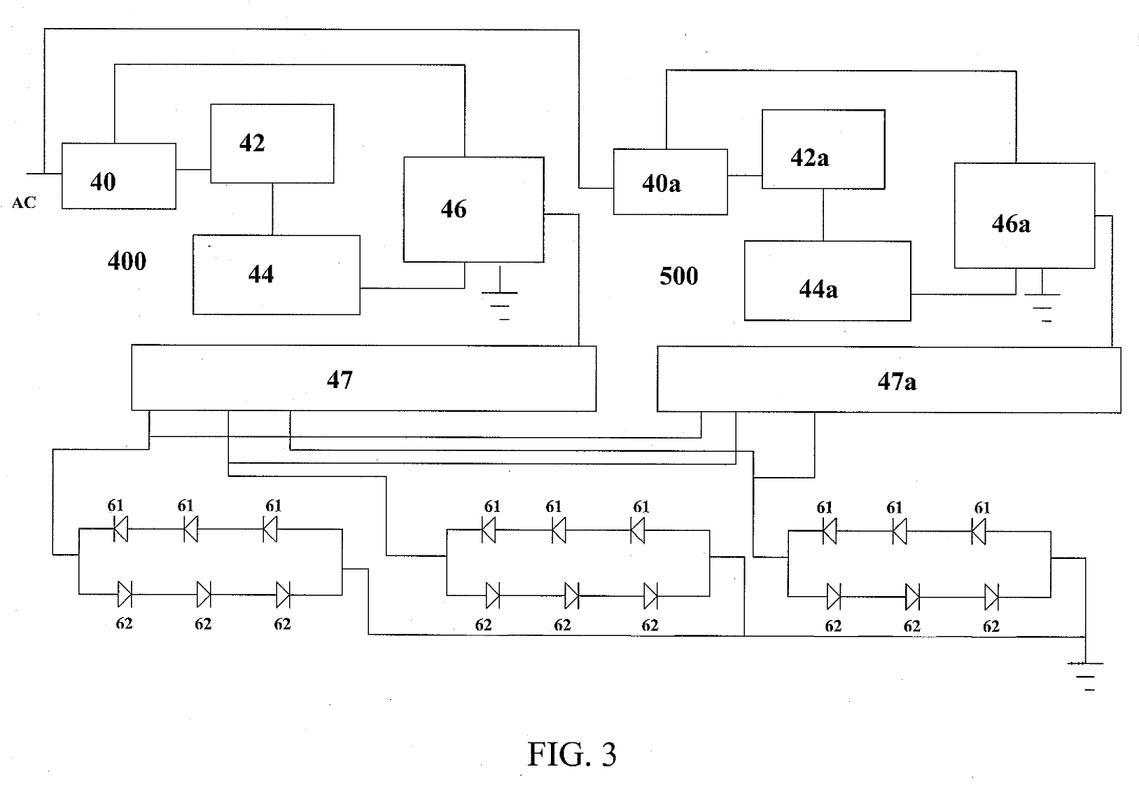

In one embodiment according to the present invention, a second drive circuit with differently or oppositely timed pulses to drive a second group of LEDs, as illustrated by FIG. 3, can be used where greater light output is desired. The use of differently or oppositely timed circuit can allow side by side LEDs coupled differently or oppositely in polarity such that every other LEDs can be on at a different time, thereby reducing individual heating time that can reduce the service life of the LEDs.

As shown in FIG. 3, a second drive circuit 500 can comprise a source power unit 40a, a voltage regulator 42a, a pulse generator 44a, and an output regulator 46a; which components can function identically to their counterparts in drive circuit 400 (source power unit 40, voltage regulator 42, pulse generator 44, and output regulator 46, respectively).

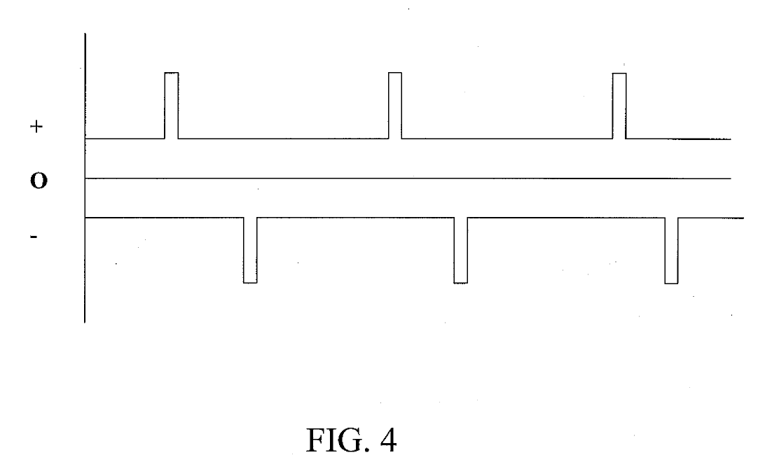

In one embodiment, drive circuits 400 and 500 can provide differently or oppositely timed pulse voltage of opposite polarity for driving one or more LEDs, so that, for example, when drive circuit 400 provides a positive voltage, drive circuit 500 provides a negative voltage, to drive the one or more LEDs. The timing of the pulses provided by drive circuit 400 and drive circuit 500 can be controlled by field effect transistors in the circuits (e.g., in output regulator 46 and 46a, respectively), so that they do not overlap (e.g., as shown in FIG. 4).

Still referring to FIG. 3, output from output regulators 46 and 46a can be communicated to LEDs 61 and LEDs 62 through resistors 47 and 47a (each of which can comprise one or more resisters), respectively. In the figure, a plurality of series circuits of LEDs 61 and a plurality of series circuits of LEDs 62 can be coupled in parallel, and these parallel circuits can be further coupled to constitute a plurality of series circuits, which in turn, can be coupled to each other in parallel. The LEDs can be connected so that a current flows through LEDs 61 in one direction, while flows through LEDs 62 in the opposite direction. This means that the type of LEDs that emit light is determined by the direction of current-flow, so that light obtained from the LED assembly at any one time is either from LEDs 61 or LEDs 62.

This feature is a significant advance from prior art in that it can provide a steady light source useful for a variety of applications while allowing the LEDs (or a group of the LEDs) to emit high power light intermittently, thereby reducing the heat generated by the LED lamp assembly. Additionally, with this arrangement, there can be more time for heat transfer from the LEDs, thus allowing for greater drive energies to be used, which can result in higher power of the light emitted by the LED lamp assembly.

The invention is illustrated by the following non-limiting Examples.

### EXAMPLES

### Example 1

### Drive Circuit

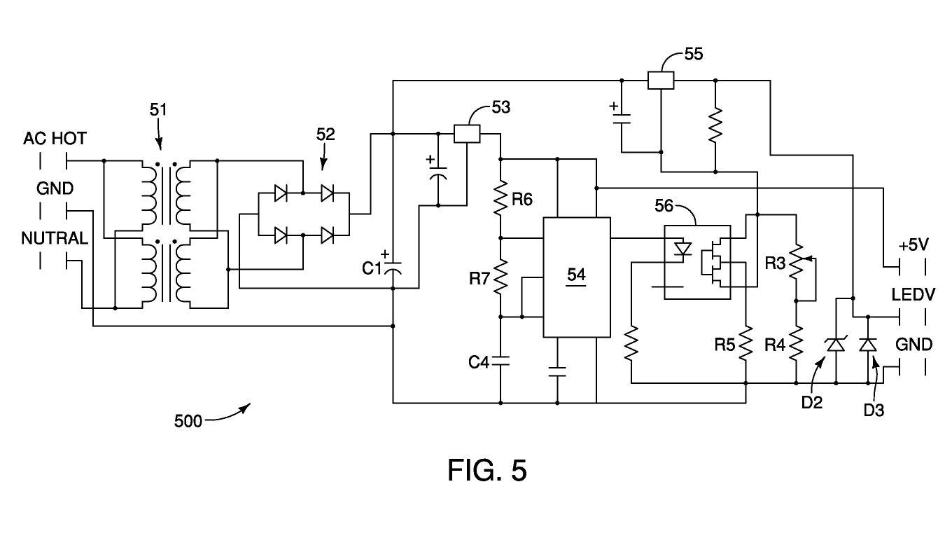

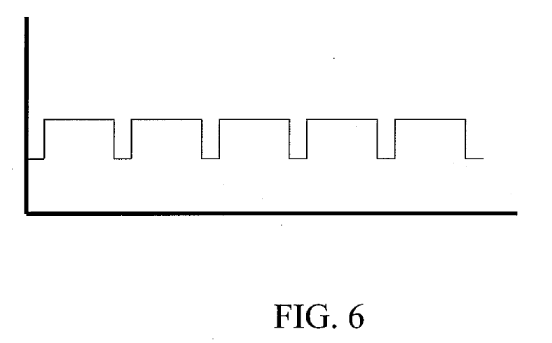

FIG. 5 illustrates a circuit diagram of a LED drive circuit 500 in accordance with embodiments of the present invention. In FIG. 5, LED drive circuit 500 comprises transformer 51 that reduces a 120 V_{AC} to 14 V_{AC} and rectifier 52 that converts AC to DC. Rectifier 52 is coupled with capacitor C1 for energy storage, which is coupled with 1A-type regulator circuit 53 that maintains a 5 V_{DC} voltage that is communicated to 555-type pulse generator 54 (which can be obtained, e.g., from Fairchild Semiconductor Corporation). Pulse generator 54 generates voltage pulses and is coupled with capacitor C4 (1 μF), resistor R6 (120 KΩ) and resistor R7 (9.1 KΩ), such that the output is “high” for t_{H}=ln 2×(R6+R7)×C4=8.95 ms, and “low” for t_{L}=ln 2×R7×C4=0.63 ms, for a total pulse repetition rate of 9.58 ms. This pulse (e.g., FIG. 6) is communicated with Z152 field effect transistor 56, causing resistor R5 (3 KΩ) to be paralleled with the series combination of potentiometer R3 (5 KΩ) and resistor R4 (1.2 KΩ) (the “on” position) for every “low” signal communicated from pulse generator 54. This “on” position shifts 5-Amp LM138 regulator 55 (which can be obtained, e.g., from National Semiconductor Corporation) from its low steady state voltage to a higher voltage.

Field effect transistor 56 is optically or LED switched, which has a relatively slow response time (e.g., 5 microseconds or longer) to voltage changes. The results of this circuit combination can output a soft start potential to a much higher potential without overshoot for driving one or more LEDs, which allows for longer service life of the LEDs. Each LED can be connected with LED driver circuit 500 via resistors, further enhancing the soft start of the drive pulses.

Circuit 500 can comprise transorb D2 and zenor diode D3 coupled in parallel, which can regulate voltage output for protecting the LEDs from being reverse biased.

For driving LEDs alternatively, a 556-type dual timer pulse generator and separate 5-Amp regulators can be used to drive different groups of LEDs at different or opposite times.

### Example 2

### Steady State and Pulse Voltage (395 nm LEDs)

For sets of three 395 nm LEDs the steady state voltage was not lower than 10.8 V outputting a drive current of 30 mA, which corresponds to 0.324 W power. For the LEDs used there was a steady low output of 9.72 lm per LED set, or 1166.4 lm for 120 sets.

The drive pulse voltage was 11.4 V and current was 240 mA, for 2.736 W of power. This provided 9849.6 lm for a pulse of less than one millisecond. The LED lamp can run with this configuration non-stop for more than eleven years. Steady state at this current, on the other hand, would substantially shorten the service life of the LEDs (e.g., to 100 hours or less).

### Example 3

### Steady State and Pulse Voltage (LW W5SN LEDs)

Each set of three LW W5SN LEDs (typical efficiency: 30 lm/W (white)) provides 225 lm at 700 mA. At 3.6 V per LED the drive power would be (3×3.6 V)×700 mA=7.56 W. This means for 11 sets of the LEDs, 85 W input would provide about 2530 lm.

Each set of the LEDs is capable of being pulsed at 2500 mA for a driver power of 12.9 V×2500 mA=32.25 W. Eleven sets of the LEDs would provide 10,642 lm at a rate comparable to the steady state of 85 W, while providing an over four-fold increase in intensity.

### Example 4

### LEDs

The LEDs' response time is set by its approximate 100 pF capacitance. With a rise time of 200 ns and a fall time of 150 ns, its shortest time period is 350 ns for a pulse frequency compatibility of about 28.5 MHz. Being able to switch on and off rapidly allows for high power light bursts with low total energy consumption.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth herein are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Certain embodiments of this invention are described herein, including the best mode known to the inventors for carrying out the invention. Of course, variations of these embodiments will become apparent to those of ordinary skill in the art upon reading the foregoing description. The inventors expect skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles according to the present invention. Other modifications that may be employed are within the scope of the invention. Thus, by way of example, but not of limitation, alternative configurations according to the present invention may be utilized in accordance with the teachings herein. Accordingly, the present invention is not limited to that precisely as shown and described.

I claim:

1. A LED lamp assembly comprising:
a substrate;
a plurality of LEDs disposed on the substrate; and
a circuit for driving the plurality of LEDs; wherein the circuit provides soft start pulses for driving the plurality of LEDs.

2. A LED lamp assembly according to claim 1, wherein the circuit comprises:
a pulse generator for generating pulses; and
a field effect transistor for switching current flow for driving the plurality of LEDs; wherein the field effect transistor switches the current flow in response to pulses generated by the pulse generator.

3. A LED lamp assembly according to claim 2, wherein the field effect transistor is optically switched and has a response time in the range of from 0.1 to 20 microsecond to pulses generated by the pulse generator.

4. A LED lamp assembly according to claim 1, wherein:
the substrate comprises an elongated structure comprising an outer surface, an inner surface, and a bore extending in the direction of the longitudinal axis of the elongated structure defining the inner surface; and
the plurality of LEDs are disposed along the outer surface of the elongated structure and are thermally coupled with the elongated structure while maintaining electrical insulation from the elongated structure.

5. A LED lamp assembly according to claim 4, wherein the elongated structure is a polygonal tubular structure.

6. A LED lamp assembly according to claim 5, wherein the cross section of the outer surface of the polygonal tubular structure is hexagonal.

7. A LED lamp assembly according to claim 4, further comprising a cover on the substrate above the plurality of LEDs.

8. A LED lamp assembly according to claim 7, wherein the cover forms a hermetic seal covering the plurality of LEDs.

9. A LED lamp assembly according to claim 7, wherein the cover comprises a fluorine polymer material.

10. A LED lamp assembly according to claim 1, wherein the plurality of LEDs are selected from the group consisting of ultra lumen LEDs and 1206 type LEDs.

11. A LED lamp assembly according to claim 1, wherein the plurality of LEDs comprises a first plurality of LEDs and a second plurality of LEDs, and the first plurality of LEDs and the second plurality of LEDs emit light at different time intervals.

12. A LED lamp assembly according to claim 11, wherein the first plurality of LEDs and the second plurality of LEDs are arranged in opposite directions relative to each other so that currents flow through the first plurality of LEDs and the second plurality of LEDs in opposite directions whereby either the first or the second plurality of LEDs emit light depending upon the direction of current flow.

13. A LED lamp assembly according to claim 11, wherein the first plurality of LEDs have different ranges of wavelength from the second plurality of LEDs.

14. A light emitting diode lamp assembly according to claim 13, wherein the first plurality of LEDs comprises ultra lumen LEDs and the second plurality of LEDs comprises 1206 type LEDs.

15. A circuit comprising:
a pulse generator for generating pulses; and
a field effect transistor for switching current flow for driving a plurality of LEDs; wherein
the field effect transistor switches the current flow in response to pulses generated by the pulse generator; and
the circuit provides soft start pulses for driving the plurality of LEDs.

16. A circuit according to claim 15, wherein the field effect transistor is optically switched and has a response time in the range of from 0.1 to 20 microsecond to pulses generated by the pulse generator.

17. A heat dissipating system for an LED lamp assembly comprising:
a substrate; and
a plurality of LEDs disposed on the substrate; wherein
the substrate comprises an elongated structure comprising an outer surface, an inner surface, and a bore extending in the direction of the longitudinal axis of the elongated structure defining the inner surface; and
the plurality of LEDs are disposed along the outer surface of the elongated structure and are thermally coupled with the elongated structure while maintaining electrical insulation from the elongated structure.

18. A heat dissipating system for an LED lamp assembly according to claim 17, wherein the elongated structure is a polygonal tubular structure, and the cross section of the outer surface of the polygonal tubular structure is hexagonal.

19. A heat dissipating system for an LED lamp assembly according to claim 17, further comprising a cover on the substrate above the plurality of LEDs.

20. A heat dissipating system for an LED lamp assembly according to claim 19, wherein the cover forms a hermetic seal covering the plurality of LEDs.
